(19) United States
(12) Patent Application Publication
(10) Pub. No.: US 2003/0041596 A1
(43) Pub. Date: Mar. 6, 2003

(54) Hydraulic system with multiple-pressure relief limits

(76) Inventors: Gary Flerchinger, Hixson, TN (US); Mark A. Keller, Valleyhead, AL (US)

Correspondence Address: David J. Hill, Paul S. Weidlich, Chambliss, Bahner & Stophel, P.C., 1000 Tallan Building, Two Union Square, Chattanooga, TN, 37402, US

(21) Appl. No.: 09/894,495

(22) Filed: Jun. 28, 2001

(51) Int. Cl. F16D 31/02

(52) U.S. Cl. 60/468

(57) ABSTRACT

The invention comprises a hydraulic system that may be operated at multiple pressure levels and is preferably adapted for use on a refuse truck. More particularly, the preferred embodiment of the invention is intended for use in performing the tasks of lifting refuse containers, dumping the contents of refuse containers, and compacting refuse. Moreover, the pressure level in the hydraulic system may be varied between the multiple maximum pressure levels manually by an operator and/or automatically in response to existing load conditions. Under normal load conditions, the maximum pressure level in the preferred hydraulic system is maintained at or below the lower maximum pressure level of the lower pressure setting of a dual pressure relief valve. When an actuator experiences increased load conditions, a means for automatically varying the maximum pressure level in the system or, in the preferred embodiment, a means for manually varying the maximum pressure level in the system is actuated so as to switch the dual pressure relief valve from the lower pressure setting to the higher pressure setting, thereby increasing the maximum pressure level in the system to the higher maximum pressure level of the higher pressure setting of the dual pressure relief valve. The maximum pressure level in the preferred system remains at the higher maximum pressure level until the means for automatically varying the maximum pressure level in the system or the means for manually varying the maximum pressure level in the system returns the dual pressure relief valve to the lower pressure setting.

### FIELD OF THE INVENTION

This invention relates generally to a hydraulic system for use with heavy equipment such as refuse trucks. More specifically, the invention is a hydraulic system that may be manually and automatically operated with different pressure relief limits depending upon existing load conditions.

### BACKGROUND AND DESCRIPTION OF THE PRIOR ART

Many refuse trucks are adapted to lift refuse containers, dump the containers into a storage compartment, and compact the refuse within the storage compartment. These functions are commonly performed by an operator who activates a variety of hydraulic actuators through a plurality of controls that are in fluid communication with a hydraulic system. Typically, these hydraulic systems include one or more pumps, relief valves, control valves, solenoid switches, and hydraulic actuators. Conventional systems, however, permit the operator to operate the actuators at only one maximum pressure level. These systems suffer from several disadvantages.

First, the force required to lift and dump refuse containers varies in relation to the weight of the container. The weight of refuse containers is usually less than about 2000 pounds, but can be as high as 8000 pounds. The conventional system, however, has no ability to differentiate between the typical 2000 pound container and the 8000 pound container. In other words, the single pressure level system maintains the same maximum level when it is lifting a 2000 pound container as it does when it is lifting an 8000 pound container. As a result, the conventional single pressure system must be equipped with components capable of lifting the 8000 pound container, and it must be operated so as to lift a container of such size at all times. Consequently, the single pressure system is inefficient and requires larger, heavier and costlier components because it operates at only one maximum pressure potential.

Similarly, the force required to compact refuse in the storage compartment of a refuse truck varies greatly depending upon the amount of refuse in the compartment. During the majority of the compacting process, the hydraulic actuator encounters little resistance other than that due to the inertia of the refuse. It is only during about the last 10% of the compacting process that significant resistance is encountered by the hydraulic actuator as it attempts to compact the refuse. The conventional single pressure level system, however, cannot differentiate between the varying resistance requirements. As a result, the conventional single pressure level system is required to operate at an excessive pressure potential for approximately 90% of the compacting process in order to provide sufficient force during the last 10% of the process. Again, this is inefficient and requires the use of oversized and costlier equipment.

Several attempts to overcome the disadvantages of the conventional constant pressure level hydraulic system have been made. For example, hydraulic systems that may be operated at varying levels of pressure have been developed. See e.g., U.S. Pat. Nos. 4,017,221; 4,468,173; 4,986,074; 5,137,846; and 5,481,872. Typically, these hydraulic systems utilize a plurality of pumps (U.S. Pat. Nos. 5,137,846; and 5,481,872), a plurality of independent circuits (U.S. Pat. No. 4,986,074), or a variable displacement pump or motor (U.S. Pat. No. 4,468,173) to vary the pressure levels available to actuators in the system. These systems, however, also suffer from disadvantages.

While tandem pumps may be used to increase the flow rate and cycle speed in a system, they are expensive and difficult to maintain and troubleshoot. Supplemental booster pumps are bulky, heavy and expensive. In addition, boosters require a separate control system and may require modification of the existing system. Systems having a plurality of independent circuits are complicated and expensive. Systems utilizing a variable displacement pump or motor are also complicated and expensive.

It would be desirable, therefore, if a hydraulic system could be provided that permitted actuators to be operated at multiple pressure levels. It would also be desirable if a hydraulic system could be provided that switched between multiple pressure levels automatically, manually or both. It would also be desirable if such a hydraulic system could be provided that does not require the use of expensive and complicated multiple pump or multiple circuit systems. It would also be desirable if a multiple-pressure hydraulic system could be provided that does not require any special maintenance techniques or operator training. It would also be desirable if a multiple-pressure hydraulic system could be provided that may be easily integrated with existing conventional pump technology without any significant modification of the existing system. It would also be desirable if a multiple-pressure hydraulic system could be provided that reduces the size, weight and cycle time of the actuator. Finally, it would be desirable if a hydraulic system could be provided that utilizes undersized actuators which are usually operated at a lower pressure level under normal load conditions and intermittently operated at a higher pressure level when required by increased load conditions.

### ADVANTAGES OF THE INVENTION

Among the advantages of the invention described herein is that it provides a hydraulic system that permits hydraulic actuators to be operated at multiple pressure levels. It is also an advantage of the invention to provide a hydraulic system that may be switched between multiple pressure levels automatically, manually or both. It another advantage of the invention to provide a multiple-pressure hydraulic system that does not require the use of expensive and complicated multiple pump or multiple circuit systems. It is still another advantage of the invention to provide a multiple-pressure hydraulic system that does not require any special maintenance techniques or operator training. It is also an advantage of the invention to provide a multiple-pressure hydraulic system that may be easily integrated with existing pump technology without any significant modification of the existing conventional system. It is yet another advantage of the invention to provide a multiple-pressure hydraulic system that reduces the size, weight and cycle time of the actuator. Finally, it is an advantage of the invention to provide a hydraulic system that utilizes undersized actuators that are usually operated at a lower pressure level under normal load conditions and intermittently operated at a higher pressure level when required by increased load conditions.

Additional advantages of this invention will become apparent from an examination of the drawings and the ensuing description.

### EXPLANATION OF TECHNICAL TERMS

As used herein, the term actuator refers to a device such as a hydraulic cylinder, a hydraulic motor, or any other hydraulic drive that operates or controls the movement of another device.

As used herein, the term control valve refers to a device that regulates the flow of fluid through a system.

As used herein, the term multiple pressure relief valve refers to a device that provides a plurality of different maximum pressure levels in a system by discharging or relieving excess pressure from the system at a plurality of different pressure settings. The preferred multiple pressure relief valve provides two different maximum pressure levels, a lower pressure setting for effecting a lower pressure level in the system and a higher pressure setting for effecting a higher pressure level in the system. It is also contemplated within the scope of the invention that the multiple pressure relief valve may employ more than two different pressure settings in order to maintain the required maximum pressure level in the system at more than two different levels. It is also contemplated within the scope of the invention that the multiple pressure relief valve may comprise a plurality of independent relief valves having different pressure settings.

As used herein, the term means for manually varying the maximum pressure level in the system refers to a device that may be manually engaged by an operator to vary the maximum pressure level in a system between a plurality of different pressure levels. While the preferred means for manually varying the maximum pressure level in the system varies the maximum pressure level in the system between two different pressure levels, it is also contemplated within the scope of the invention that the means for manually varying the maximum pressure level in the system may vary the maximum pressure level in a system between more than two predetermined maximum pressure levels.

As used herein, the term pilot signal refers to a sign, signal, or impulse indicating the load conditions experienced by one or more hydraulic actuators.

As used herein, the term pressure switch refers to a device that automatically determines the load conditions experienced by one or more hydraulic actuators and automatically varies the maximum pressure level in a system between a plurality of maximum pressure levels in response to the existing load conditions.

As used herein, the term shuttle valve refers to a valve that is adapted to regulate the flow of fluid through a system by moving between and open and closed position in a direction substantially parallel to the movement of the fluid along a predetermined path.

As used herein, the term solenoid valve refers to a valve actuated by a magnetic field produced in a solenoid to control the flow of gas or fluid in a system.

### SUMMARY OF THE INVENTION

The invention described herein comprises a hydraulic system that may be operated at multiple pressure levels. In the preferred embodiment of the invention, the hydraulic system is adapted for use on a refuse truck. More particularly, the preferred embodiment of the invention is intended for use in performing the tasks of lifting refuse containers, dumping the contents of refuse containers, and compacting refuse. Moreover, the pressure level in the hydraulic system may be varied manually by an operator and/or automatically in response to existing load conditions, and in the preferred embodiment, manually by an operator.

The hydraulic system comprises a hydraulic actuator having a cap end and a rod end. The hydraulic actuator is in fluid communication with a hydraulic pump that is adapted to provide hydraulic fluid under pressure to the hydraulic actuator. A control valve that is adapted to control the flow of fluid to the cap end and the rod end of the actuator is in fluid communication with the hydraulic actuator. The system also includes a multiple pressure relief valve having plurality of pressure level settings that are adapted to vary the maximum pressure level in the system between a plurality of maximum pressure levels. The preferred multiple pressure relief valve has a lower pressure setting and a higher pressure setting and is adapted to vary the maximum pressure limit in the system between the lower maximum pressure level of the lower pressure setting of the multiple pressure relief valve and the higher maximum pressure level of the higher pressure setting of the multiple pressure relief valve in response to existing load conditions. The preferred system also includes means for automatically varying the maximum pressure level in the system and, in the preferred embodiment, means for manually varying the maximum pressure level in the system, preferably between the lower maximum pressure level of the lower pressure setting of the multiple pressure relief valve and the higher maximum pressure level of the higher pressure setting of the multiple pressure relief valve. In addition, the preferred system includes a switching device that is in fluid communication with the means for automatically varying the maximum pressure level in the system, and the multiple pressure relief valve. The switching device is adapted to switch between an open and closed position in order to vary the pressure setting of the multiple pressure relief valve.

Under normal load conditions, the maximum pressure level in the preferred hydraulic system is maintained at or below the lower maximum pressure level of the lower pressure setting of the multiple pressure relief valve. When an actuator experiences increased load conditions, the means for automatically varying the maximum pressure level in the system or the means for manually varying the pressure level in the system (if present in the system) is actuated so as to switch the multiple pressure relief valve from the lower pressure setting to the higher pressure setting, thereby increasing the maximum pressure level in the system to the higher pressure level of the higher pressure setting of the multiple pressure relief valve. The maximum pressure level in the system remains at the higher pressure level until the means for automatically varying the maximum pressure level in the system or the means for manually varying the maximum pressure level in the system (if present in the system) returns the multiple pressure relief valve to the lower pressure setting.

In order to facilitate an understanding of the invention, the preferred embodiments of the invention are illustrated in the drawings, and a detailed description thereof follows. It is not intended, however, that the invention be limited to the particular embodiments described or to use in connection with the apparatus illustrated herein. Various modifications and alternative embodiments such as would ordinarily occur to one skilled in the art to which the invention relates are also contemplated and included within the scope of the invention described and claimed herein.

### BRIEF DESCRIPTION OF THE DRAWINGS

The presently preferred embodiments of the invention are illustrated in the accompanying drawings, in which like reference numerals represent like parts throughout, and in which:

FIG. 1 is a side view of a refuse vehicle to which the invention is mounted.

FIG. 1A is a fluid circuit diagram of a preferred embodiment of the invention.

FIG. 2 is a fluid circuit diagram of first alternative embodiment of the invention having a single pilot source for regulating the pressure level in the system.

FIG. 3 is a fluid circuit diagram of a second alternative embodiment of the invention having a shuttle valve for regulating the pressure level in the system.

FIG. 4 is a fluid circuit diagram of a third alternative embodiment of the invention having a pair of shuttle valves for regulating the pressure level in the system.

FIG. 5 is a fluid circuit diagram of a fourth alternative embodiment of the invention having a sequence valve for switching the pressure setting in the multiple pressure relief valve.

FIG. 6 is a fluid circuit diagram of a fifth alternative embodiment of the invention having a pair of independent relief valves for regulating the pressure level in the system.

FIG. 7 is a fluid circuit diagram of a sixth alternative embodiment of the invention having three independent relief valves for regulating the pressure level in the system.

### DESCRIPTION OF THE PREFERRED EMBODIMENTS OF THE INVENTION

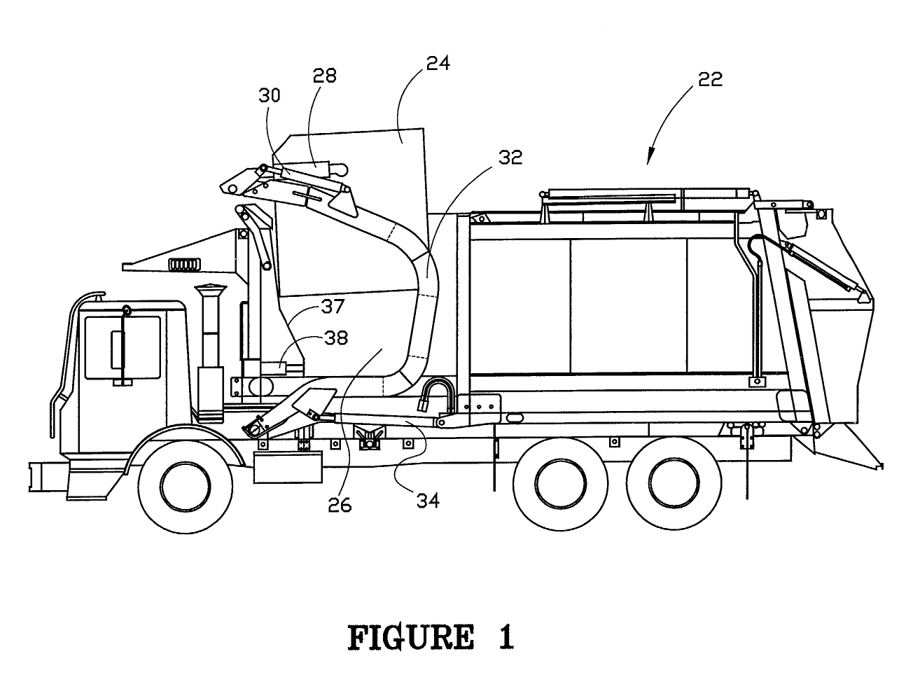

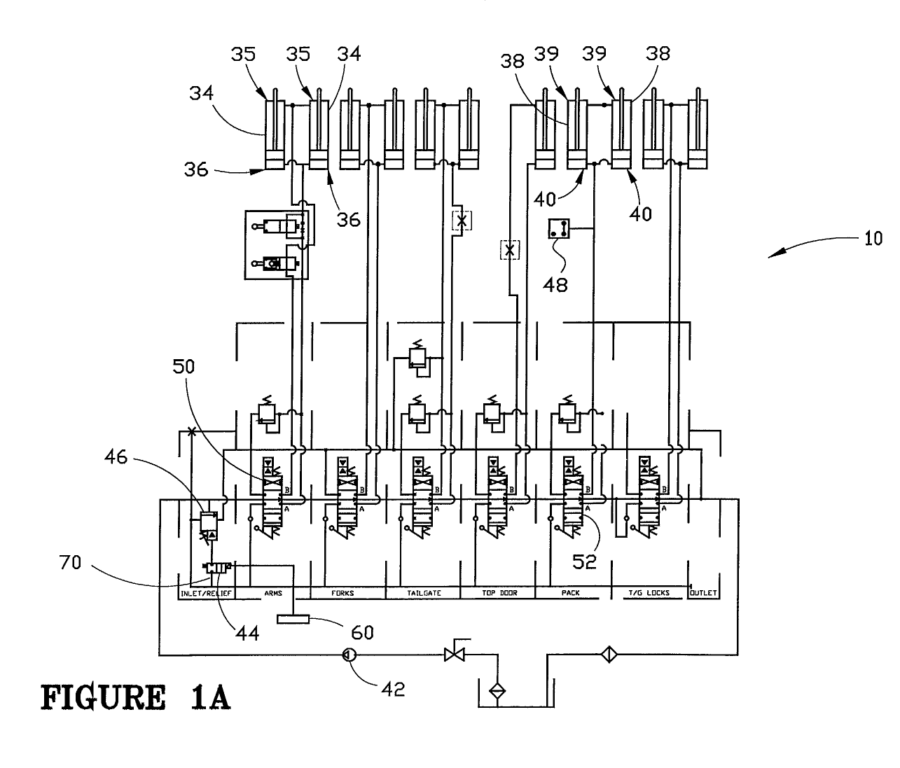

The preferred hydraulic systems of the invention are illustrated in FIGS. 1 through 7. As shown in FIG. 1, the preferred embodiments of the invention are adapted for use in connection with a refuse collection vehicle such as truck 22. Truck 22 is adapted to collect refuse from containers such as commercial-type refuse container 24. Truck 22 comprises a plurality of hydraulic actuators that are adapted to secure refuse container 24, lift the refuse container above storage compartment 26, dump the contents of the refuse container into the storage compartment, and return the refuse container to the ground. Truck 22 also includes a pair of retracting forks 28 that are adapted to secure refuse container 24 during the lifting, dumping, and lowering process. A pair of retracting fork actuators 30 are attached to retracting forks 28 and a pair of lifting arms 32. Lifting arms 32 are adapted to lift refuse container 24 off the ground and above the storage compartment 26 such that the contents of the refuse container may be dumped into storage compartment 26. A pair of lifting arm actuators 34 are attached to lifting arms 32 and the body of truck 22. The truck also comprises packer ram 37 that is adapted to compact refuse deposited into storage compartment 26. A pair of packer ram actuators 38 (only one of which is shown) are attached to packer ram 37 and the body of vehicle 22.

The plurality of hydraulic actuators illustrated in FIG. 1 may be connected to the hydraulic systems illustrated in FIGS. 1A through 7. As shown in FIGS. 1Aa through 7, additional actuators such as lifting fork, tailgate, top door and tailgate lock actuators may be connected to the system. The hydraulic systems of FIGS. 1A through 7 are adapted to provide multiple maximum pressure levels to the plurality of hydraulic actuators depending upon the existing conditions. More particularly, the preferred hydraulic systems shown in FIGS. 1A through 7 allow the hydraulic actuators to be manually and/or automatically switched between different pressure levels, preferably a lower pressure level and a higher pressure level, depending upon the existing load requirements. Under normal load requirements, the preferred hydraulic systems of the invention, including the actuators, operate at a lower maximum pressure level. Because the preferred systems of the invention normally operate at a pressure level lower than the constant pressure level of conventional systems, smaller, faster, lighter, and less expensive components can be used. When the preferred systems of the invention encounter increased load conditions, they may be temporarily operated at a higher maximum pressure level in order to increase the force applied by one or more hydraulic actuators to the existing load. The maximum pressure level in the preferred systems may be increased automatically or manually. Because the preferred systems of the invention operate at the higher pressure level only intermittently, the smaller, faster, lighter and less expensive actuators can withstand the increased pressure level. In the end, the multiple pressure systems of the invention reduce costs and cycle times (see Table I. below).

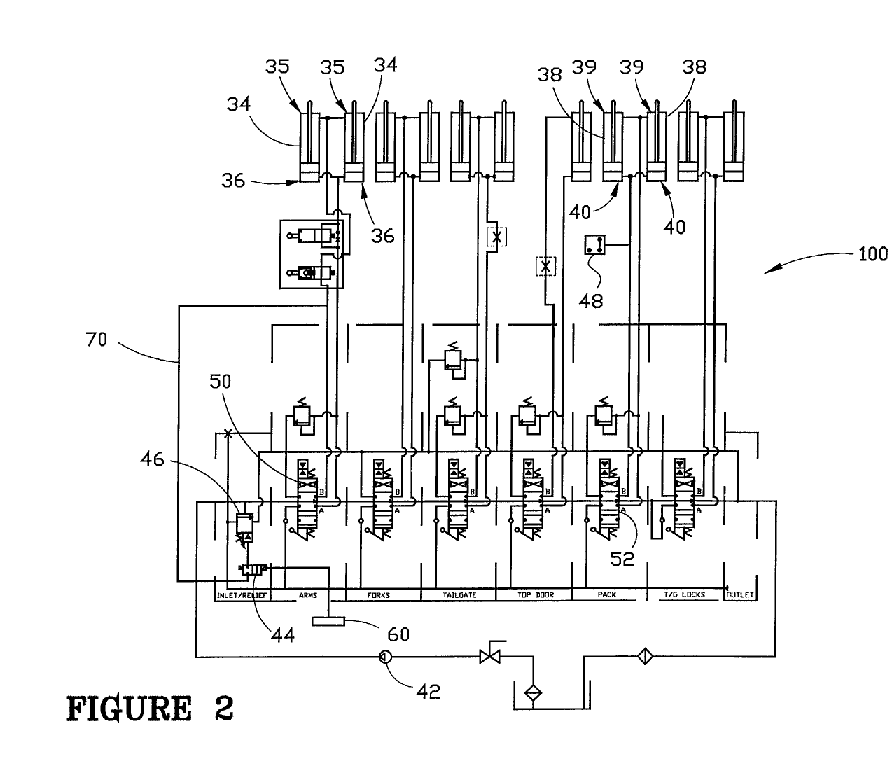

Circuit diagrams of the preferred embodiments of the invention are illustrated in FIGS. 1A through 7. FIG. 1A illustrates a preferred embodiment of the hydraulic system of the invention. As shown in FIG. 2, hydraulic system 10 comprises pump 42, high pressure enable solenoid valve 44, multiple pressure relief valve 46, lifting arm actuators 34, packer ram actuators 38, packer pressure switch 48, lifting arm control valve 50, packer ram control valve 52, means 60 for manually varying the pressure in the system, and pilot pressure line 70. Lifting arm actuators 34, packer ram actuators 38, pump 42, high pressure enable solenoid valve 44, multiple pressure relief valve 46, packer pressure switch 48, lifting arm control valve 50, packer ram control valve 52, and pilot pressure line 70 are in fluid communication with each other. Means 60 for manually varying the maximum pressure level in the system and packer pressure switch 48 are in electrical communication with high pressure enable solenoid valve 44. The various components of hydraulic system are connected using any suitable conventional hydraulic circuit lines.

Pump 42 may be any suitable conventional pump that is adapted to provide fluid under pressure to lifting arm actuators 34 and packer ram actuators 38. It is also contemplated that pump 42 may provide fluid under pressure to more or less than two hydraulic actuators. Preferred pump 42 is a constant (non-variable) displacement pump. It is also contemplated within the scope of the invention that pump 42 may be any suitable conventional device adapted to provide fluid under pressure to hydraulic actuators. It is also contemplated within the scope of the invention that a conventional power-supplying device such as a motor may be used to provide pump 42 with power. Preferred pump 42 is in continuous operation while the system is in operation.

Lifting arm actuators 34 may be any suitable conventional hydraulic cylinders having rod ends 35 and cap ends 36. Lifting arm actuators 34 are adapted to apply pushing forces to lifting arms 32 (see FIG. 1). As shown in FIG. 1A, lifting arm actuators 34 are double-acting actuators; i.e., actuators 34 apply pushing and pulling forces to lifting arms 32 as a result of the alternating introduction of pressurized fluid to rod ends 35 and cap ends 36. The alternating introduction of pressurized fluid to lifting arm actuators 34 is controlled by lifting arm control valve 50. Lifting arm control valve 50 may be any suitable conventional control valve adapted to permit pressurized fluid to be alternatingly introduced to the cap ends and the rod ends of a hydraulic cylinder. While FIG. 1A illustrates double-acting lifting arm actuators, it is also contemplated within the scope of the invention that the lifting arm actuators, as well as any other actuators, may be single-acting actuators wherein pressurized fluid is introduced to only the cap end or the rod end of the actuator. Lifting arm actuators 34 are in fluid communication with pump 42.

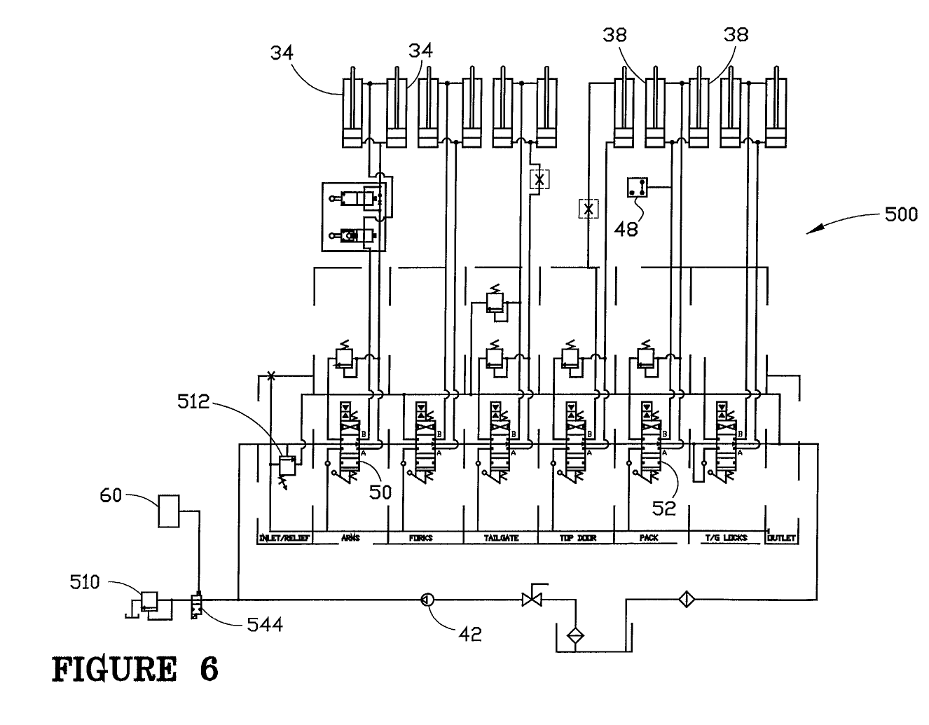

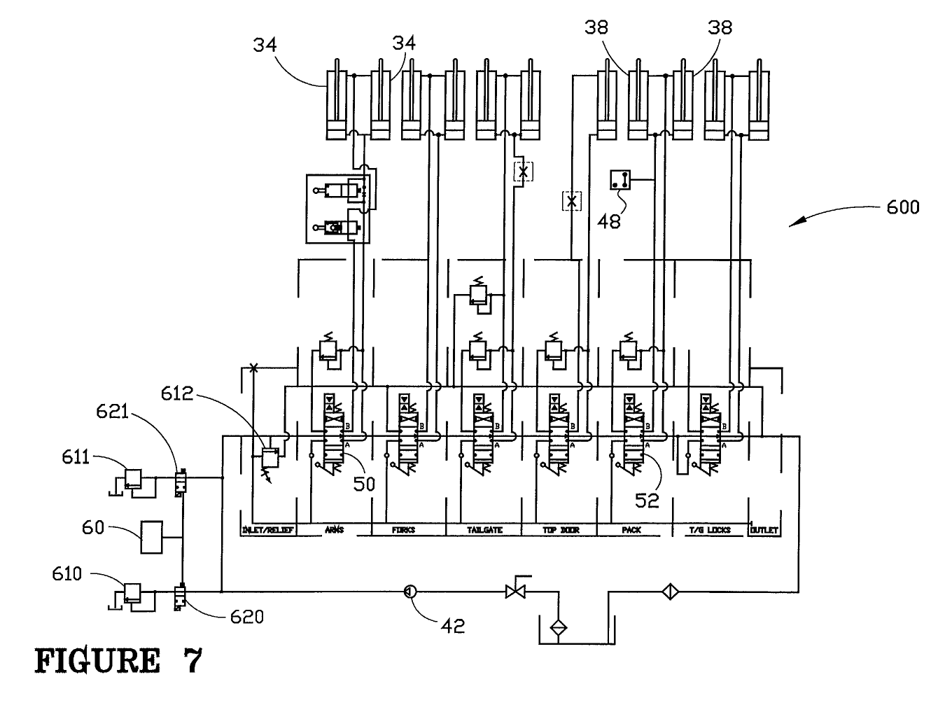

Multiple pressure relief valve 46 may be any suitable relief valve adapted to prevent the pressure level in a hydraulic system from exceeding different predetermined levels. Preferred multiple pressure relief valve 46 has two different pressure settings, a lower pressure setting that sets a lower maximum pressure level in the system and a higher pressure setting that sets a higher maximum pressure level. Preferred multiple pressure relief valve 46 is also actuatable between the two different pressure settings that produce the two different maximum pressure levels in the system. It is also contemplated within the scope of the invention that the multiple pressure relief valve may employ more than two different pressure settings in order to maintain the required maximum pressure level in the system at more than two different levels. It is also contemplated within the scope of the invention that the multiple pressure relief valve may comprise a plurality of independent relief valves having different pressure settings. (See FIGS. 6 and 7). Multiple pressure relief valve 46 is in fluid communication with pump 42.

A switching device such as high pressure enable solenoid valve 44 is in fluid communication with multiple pressure relief valve 46, means 60 for manually varying the maximum pressure level in the system, and the means for automatically varying the maximum pressure level in the system. The switching device may be any suitable conventional device adapted to move between an open and a closed position and vary the maximum pressure level in the system. High pressure enable solenoid valve 44 may be any suitable conventional solenoid valve that is actuated by the magnetic field produced in a solenoid to control the flow of fluid in a hydraulic system. Solenoid valve 44 is adapted to receive a signal from the means for automatically varying the maximum pressure level in the system and/or the means for manually varying the maximum pressure level in the system. Solenoid valve 44 is also adapted to switch multiple pressure relief valve 46 between different pressure settings, preferably a lower pressure setting and a higher pressure setting, in response to one or more signals.

Packer ram actuators 38 include rod ends 39 and cap ends 40. Packer actuators 38 apply pushing and retracting forces to packer ram 37 as a result of the alternating introduction of pressurized fluid to the rod ends and cap ends of the packer ram actuators. The alternating introduction of pressurized fluid to the rod ends and the cap ends of packer ram actuators 38 is accomplished by control valve 52 which may be any suitable conventional control valve adapted to permit pressurized fluid to be alternatingly introduced to the cap ends and rod ends of a hydraulic cylinder. As shown in FIG. 1A, the packer ram actuators are double-acting. However, it is contemplated that the packer ram actuators, like any other actuators, may be single-acting. Packer ram actuators 38 are in fluid communication with pump 42.

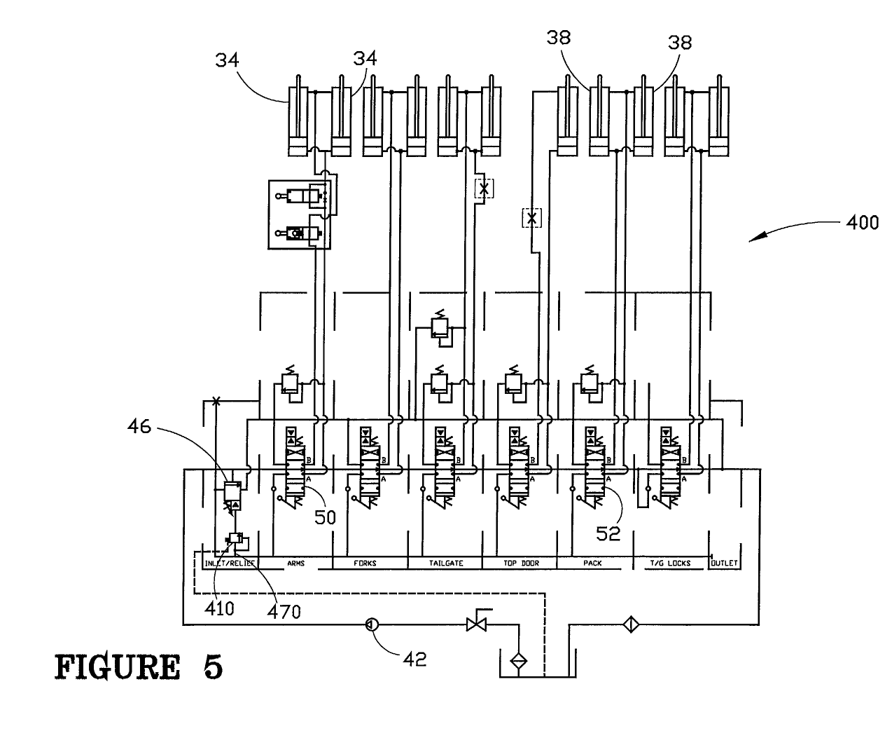

The means for automatically varying the maximum pressure level in the system is adapted to automatically determine the existing load conditions in the packer ram actuators and automatically vary the maximum pressure level in the system to meet the existing load requirements by switching solenoid valve 44 between an open and closed position, thereby switching multiple pressure relief valve 46 between its different pressure settings. As shown in FIG. 1A, the means for automatically varying the maximum pressure level in the system may be any suitable conventional device such as packer pressure switch 48. The means for automatically varying the maximum pressure level in the system may be in communication with solenoid valve 44, or it may be in communication with some other switching device such as a pneumatic valve. The means for automatically varying the maximum pressure level in the system may be a sequence valve as shown in FIG. 5 or some other suitable conventional automatic switching device. Thus, a sequence valve such as is shown in FIG. 5 serves as both the means for automatically varying the maximum pressure level in the system and the switching device.

Preferred packer pressure switch 48 is in communication with packer ram actuators 38, but it is also contemplated within the scope of the invention that the means for automatically varying the maximum pressure level in the system may be in communication with lifting arm actuators 34 and/or other actuators such as lifting fork, tailgate, top door, and tailgate lock actuators. It is also contemplated that the means for automatically varying the maximum pressure level in the system may be in communication with more than one switching device.

While FIG. 1A illustrates a system in which the means for automatically varying the maximum pressure level in the system varies the maximum pressure level in the system between two different pressure settings, it is also contemplated within the scope of the invention that the means for varying the maximum pressure level in the system may vary the maximum pressure level in a system between more than two predetermined maximum pressure levels. It is also contemplated that an independent sensor component may be used to automatically determine the load conditions experienced by one or more hydraulic actuators. Such a sensor device could be placed in communication with one or more hydraulic actuators and one or more means for automatically varying the maximum pressure level in the system such as packer pressure switch 48 in order to vary the maximum pressure level in the system.

Means 60 for manually varying the maximum pressure level in the system may be any suitable conventional mechanism or device adapted to permit solenoid valve 44 to be manually switched between open and closed conditions. Means 60 for manually varying the maximum pressure level in the system is in electrical communication with solenoid valve 44. The means for manually varying the pressure level in the system may also be adapted to switch some other similar switching device between open and closed conditions. By switching solenoid valve 44 between open and closed conditions, means 60 for manually varying the maximum pressure level in the system varies the pressure setting of the multiple pressure relief valve. Pilot signal line 70 is in fluid communication with solenoid valve 44. Pilot signal line 70 is adapted to communicate a pilot signal to dual pressure relief valve 46 via high pressure enable solenoid valve 44 (FIG. 1A) or sequence valve 410 (FIG. 5). Solenoid valve 44 receives its signal to open automatically from pressure switch 48 and/or manually from means 60 for manually varying the maximum pressure level in the system. The pilot signal directs the pressure level under which the hydraulic system will operate. It is also contemplated within the scope of the invention that pilot signal line 70 may be in communication with sequence valve 410 or some other similar switching device adapted to be switched between open and closed positions. It is also contemplated that pilot signal line 70 may receive pilot signals from other pilot signal transmitting devices.

In operation, system 10 is adapted to vary the maximum pressure level in the system in response to a pilot signal from the means for automatically varying the maximum pressure level in the system. Solenoid valve 44 may receive a pilot signal from pressure switch 48 via pilot signal line 70 and/or a signal from means 60 for manually varying the maximum pressure level in the system. When solenoid valve 44 receives a signal, it is actuated to an open condition, thereby switching the multiple pressure relief valve to a higher pressure setting. As a result, the maximum pressure level in the system increases to the level of the higher pressure setting. In the absence of a signal, solenoid valve 44 switches to a closed condition, thereby switching the multiple pressure relief valve to a lower pressure setting. As a result, the maximum pressure level in the system decreases to the level of the lower pressure setting.

FIG. 2 illustrates a first alternative embodiment of the hydraulic system of the invention. Hydraulic system 100 comprises each of the components of system 10, but system 100 is adapted to receive a pilot signal via pilot signal line 170 from only one pair of actuators; namely, lifting arms actuators 34. As shown in FIG. 2, only the lifting arm actuators are in fluid communication with solenoid valve 44 via pilot signal line 170. As a result, solenoid valve 44 may receive a pilot signal from only the lifting arm actuators. It is contemplated, however, that pilot signal line 170 may be connected to any one or more pairs of actuators in order to communicate a pilot signal to solenoid valve 44, as illustrated in FIG. 1A.

In operation, hydraulic system 100 operates in substantially the same manner as system 10 illustrated in FIG. 1A.

Solenoid valve 44 of hydraulic system 100, however, may receive a pilot signal via pilot signal line 70 from only a single source, i.e. rod end 35 of lifting actuator 34. When the pump is in an unloaded condition, the absence of a load causes the pressure in the system to fall below a predetermined level (i.e., the lower pressure setting of the multiple pressure relief valve). Without any signal, the solenoid valve remains in a closed condition, and the multiple pressure relief valve remains switched to the lower pressure setting. As a result, the pressure in the system is maintained at the lower maximum pressure level. By contrast, when the pump is in a loaded condition for driving the actuators, and the load causes the pressure in the system to exceed a predetermined level (i.e., the lower pressure setting of the multiple pressure relief valve), a pilot pressure will be produced in the pilot pressure signal line 170. The signal from means 60 switches the solenoid valve to an open condition. When the solenoid valve is in an open condition, the multiple pressure relief valve switches to the higher pressure setting, thereby increasing the maximum pressure level in the system to the higher maximum pressure level. As a result, the pressure level in system may be increased only when raising the lifting arms. If the solenoid valve is activated at any other time, it will switch, but there will not be sufficient pressure available to switch the multiple pressure relief valve to the higher pressure setting. As a result, the remainder of the system is protected from experiencing higher pressures.

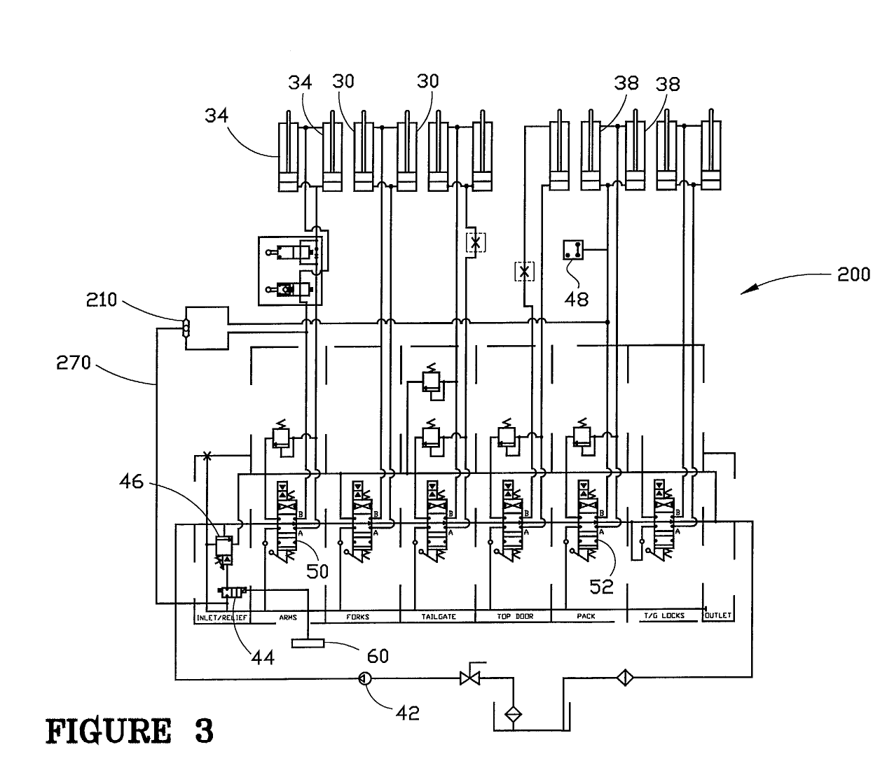

FIG. 3 illustrates a second alternative embodiment of the hydraulic system of the invention. As shown in FIG. 3, hydraulic system 200 comprises all of the components of hydraulic system 100. Hydraulic system 200, however, is adapted to receive a pilot signal from two different sources, i.e. lifting arm actuators 34 and packer ram actuators 38, via pilot pressure line 270. Hydraulic system 200 may receive a pilot signal from two different sources as a result of shuttle valve 210. Shuttle valve 210 is in fluid communication with solenoid valve 44, lifting arm actuators 34 and packer ram actuators 38. It is contemplated within the scope of the invention, however, that shuttle valve 210 may be in fluid communication with sequence valve 410 or any suitable conventional switching device. It is also contemplated that shuttle valve 210 may be in fluid communication with any one or more of the plurality of hydraulic actuators of the system. As shown in FIG. 3, shuttle valve 210 is adapted to permit the pressure level in the system to be increased only when raising lifting arms 32 or extending packer ram 37.

In operation, hydraulic system 200 functions in substantially the same manner as system 100, except that system 200 is adapted to receive pilot signals from two different sources via pilot pressure line 270. As a result, the solenoid valve may be actuated by a pilot signal from either the lifting arm actuators or the packer ram actuators or both. Upon receiving a signal, the solenoid valve opens and thereby switches the multiple pressure relief valve to the higher pressure setting. Thus, the pressure level in the system is increased to the higher maximum pressure level. In the absence of a signal, the solenoid valve closes, thereby switching the multiple relief valve to the lower pressure setting. Thus, the pressure in the system is maintained at the lower maximum pressure level of the multiple pressure relief valve.

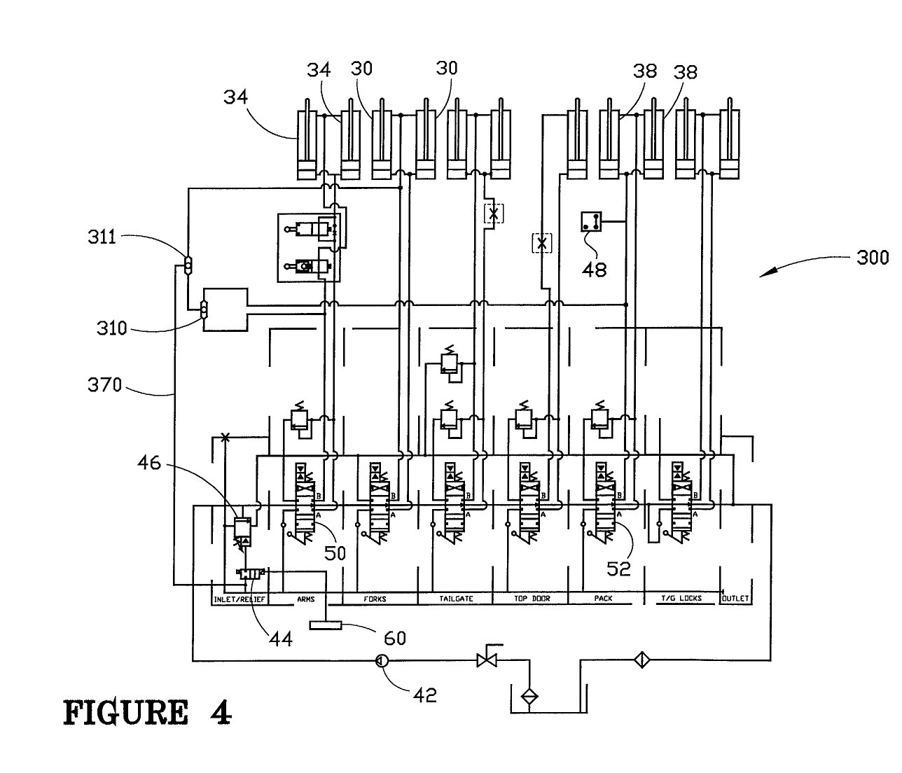

FIG. 4 illustrates a third alternative embodiment of the hydraulic system of the invention. As shown in FIG. 4, hydraulic system 300 comprises all of the components of hydraulic system 100. Hydraulic system 300, however, is adapted to receive a pilot signal from three different sources through the use of a pair of shuttle valves 310 and 311 via pilot signal line 370. Shuttle valves 310 and 311 are in fluid communication with each other and solenoid valve 44. Shuttle valve 310 is in fluid communication with lifting arm actuators 34 and packer ram actuators 38. Shuttle valve 311 is in fluid communication with retracting fork actuators 30. It is also contemplated within the scope of the invention that more than two shuttle valves may be provided in order for the system to receive a pilot signal from more than three different hydraulic actuators. Shuttle valves 310 and 311 are adapted to permit the pressure in the system to be increased only when the forks are retracted, the lifting arms are raised or the packer ram is extended. In operation, system 300 operates in substantially the same manner as system 200, except that a pilot signal may be received from three different sources in system 300.

FIG. 5 illustrates a fourth alternative embodiment of the hydraulic system of the invention in which an alternative switching device is provided. As shown in FIG. 5, hydraulic system 400 comprises high pressure enable sequence valve 410. Sequence valve 410 replaces high pressure enable solenoid valve 44 and packer pressure switch 48, as illustrated in FIGS. 1A through 4. Like solenoid valve 44, sequence valve 410 is in fluid communication with multiple pressure relief valve 46. Sequence valve 410 is adapted to open at a predetermined pressure level. Sequence valve 410 may receive a pilot signal via pilot signal line 470.

In operation, system 400 functions in substantially the same manner as system 100, except that sequence valve 410 automatically varies the pressure level in hydraulic system 400 whenever the predetermined pressure level is exceeded at any of the actuators. System 400, unlike the systems having solenoid valve 44, has no means for manually varying the maximum pressure level in the system. As a result, the hydraulic systems having solenoid valve 44 permit the pressure in the system to be increased only when signaled to do so.

FIG. 6 illustrates a fifth alternative embodiment of the hydraulic system of the invention. As shown in FIG. 6, hydraulic system 500 comprises low pressure relief valve 510 and high pressure relief valve 512. Low pressure relief valve 510 and high pressure relief valve 512 replace multiple pressure relief valve 46 illustrated in FIGS. 1A through 5. Low pressure relief valve 510 is in fluid communication with high pressure enable solenoid valve 544 and one or more hydraulic actuators.

In operation, hydraulic system 500 functions in substantially the same manner as system 100 having multiple pressure relief valve 46, except that two different relief valves control the maximum pressure level in the system instead of a single relief valve having two different pressure settings. When the high pressure enable solenoid valve of hydraulic system 500 is not actuated, the system maintains a maximum pressure level at or below the pressure setting of the low pressure relief valve. This setting could be used during operation under normal load conditions. When the high pressure enable solenoid valve is actuated, the maximum pressure level in the system increases to about the pressure setting of the high pressure relief valve. This setting could be used to raise the lifting arms under heavy load conditions or actuate the packer ram when the storage compartment is nearly full of refuse.

FIG. 7 illustrates a sixth alternative embodiment of the hydraulic system of the invention. As shown in FIG. 7, hydraulic system 600 comprises three relief valves. Low pressure relief valve 610, medium pressure relief valve 611 and high pressure relief valve 612 are provided so that the system may be operated at three different pressure levels. A pair of high pressure enable solenoid valves 620 and 621 are also provided. High pressure enable solenoid valve 620 is in fluid communication with low pressure relief valve 610 and high pressure enable solenoid valve 621 is in fluid communication with medium pressure relief valve 611. Means 60 for manually varying the maximum pressure level in the system communicates with the solenoid valves. It is contemplated that one or more means 60 may be provided to switch solenoid valves between open and closed conditions independently. It is also contemplated that the means for manually varying the maximum pressure level in the system may be in communication with more than one switching device. It is also contemplated within the scope of the invention that more than three separate and distinct relief valves and more than two separate and distinct solenoid valves may be used to produce more than three different pressure levels in the system.

In operation, hydraulic system 600 functions in substantially the same manner as system 500, except that the pressure level in the system is controlled by three different relief valves and two different solenoid valves instead of two different relief valves and one solenoid valve. When none of the high pressure enable solenoid valves of hydraulic system 600 are actuated, the system maintains a maximum pressure level at or below the pressure setting of the low pressure relief valve. This setting could be used during operation under normal load conditions. When the medium pressure enable solenoid valve is actuated, the maximum pressure level in the system increases to the pressure setting of the medium pressure relief valve. This setting could be used to raise the lifting arms. When both the medium pressure enable solenoid valve and the high pressure enable solenoid valve are actuated, the maximum pressure level in the system increases to the pressure setting of the high pressure relief valve. This setting could be used for extending the packer ram.

The foregoing descriptions of the various embodiments of the hydraulic system of the invention demonstrate the advantages of the invention. More particularly, the hydraulic systems described above permit the use of smaller, lighter, less expensive, and faster hydraulic components to accomplish the same functions as the larger, heavier, more expensive, and slower hydraulic components used with conventional hydraulic systems. Below is a table illustrating the advantages that may be achieved using the multiple-pressure level hydraulic system of the invention in connection with arm cylinder 34 and packer cylinder 38 illustrated in FIG. 1. The figures in the top row of each table below represent results achieved using systems utilizing conventional hydraulic actuators. The figures in the bottom row of each table below represent results achieved using the hydraulic system and the smaller, lighter, faster and less expensive actuators of the invention described herein.

TABLE I
ARM CYLINDER

| | | | | | | | net force | | | | | | press |
|---|---|---|---|---|---|---|---|---|---|---|---|---|---|
| | | | | | | diff | @ | cyl | ext and | retract | total | | needed |
| bore | rod | bore | rod | bore area | rod area | area | 2500 or | stroke | volume | volume | volume | % reduction | to = |
| (mm) | (mm) | (in) | (in) | (in²) | (in²) | (in²) | 3500 psi | (in) | (in³) | (in³) | (in³) | cycle time | today |
| 115 | 63 | 4 53 | 2 48 | 16 11 | 4 83 | 11 28 | 28200 lb | 41 5 | 668 565 | 468 12 | 1136 685 | | 2500 |
| 100 | 50 | 3.94 | 1.97 | 12.19 | 3.05 | 9.14 | 31990 lb | 41.5 | 505.885 | 379.31 | 885.195 | 22% | 3085 |

PACKER CYLINDER

| | | | | | | | ext force | | | | | | press |
|---|---|---|---|---|---|---|---|---|---|---|---|---|---|
| | | | | | | | @ | cyl | ext | net | total | reduction | needed |
| bore | rod | bore | rod | bore area | rod area | diff | 2500 or | stroke | volume | volume | volume | cycle | to = |
| (mm) | (mm) | (in) | (in) | (in²) | (in²) | area | 3500 psi | (in) | (in³) | (in³) | (in³) | time | today |
| 140 | 100 | 5 51 | 3 94 | 23 83 | 12 19 | 11 64 | 59585 lb | 63 | 1501 29 | 733 32 | 2234 61 | | 2500 |
| | | 4.5 | 3.5 | 15.9 | 9.62 | 6.28 | 55650 lb | 63 | 1001.7 | 395.64 | 1394.34 | 37% | 3747 |

The hydraulic systems of the invention also have several other advantages as compared to conventional hydraulic systems. For example, the hydraulic systems of the invention require no special maintenance or operator training. The systems of the invention are adapted to work with current gear pump technology and other existing pump technology. In addition, the systems of the invention are capable of controlling the maximum pressure level in hydraulic cylinders as well as other hydraulic actuators such as hydraulic motors.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations that would be obvious to those skilled in the art to which the invention relates, and such modifications and adaptations are intended to be comprehended within the meaning and range of equivalents of the appended claims.

What is claimed is:

1. A hydraulic system having multiple pressure relief limits, said system comprising:
(a) a hydraulic actuator having a cap end and a rod end;
(b) a hydraulic pump that is in fluid communication with the hydraulic actuator, said pump being adapted to provide hydraulic fluid under pressure to said actuator;
(c) a control valve that is in fluid communication with the hydraulic actuator and the hydraulic pump, said control valve being adapted to control the flow of fluid to the cap end and the rod end of the hydraulic actuator;
(d) a multiple pressure relief valve that is in fluid communication with the hydraulic pump, the actuator, and the control valve, said multiple pressure relief valve having a plurality of settings adapted to maintain a plurality of maximum pressure levels in the system;
(e) means for automatically varying the maximum pressure level in the system between the plurality of maximum pressure levels of the multiple pressure relief valve;
(f) a switching device that is in fluid communication with the multiple pressure relief valve and the means for automatically varying the maximum pressure level in the system, said switching device being adapted to switch between an open position and a closed position and vary the pressure setting of the multiple pressure relief valve;
wherein the maximum pressure level in the system may be varied between the plurality of maximum pressure levels of the multiple pressure relief valve by the means for automatically varying the maximum pressure level in the system.

2. The hydraulic system of claim 1 wherein the switching device is a solenoid valve that is in fluid communication with the multiple pressure relief valve.

3. The hydraulic system of claim 1 wherein the switching device and the means for automatically varying the maximum pressure level in the system comprise a sequence valve that is in fluid communication with the multiple pressure relief valve.

4. The hydraulic system of claim 1 which includes a plurality of actuators that are in fluid communication with the pump and the control valve, said system further comprising a shuttle valve that is in fluid communication with the multiple pressure relief valve and the plurality of actuators such that said multiple pressure relief valve may be switched between the plurality of pressure settings in response to the load conditions existing at more than one actuator.

5. The hydraulic system of claim 1 which includes a plurality of actuators that are in fluid communication with the pump and the control valve, said system further comprising a plurality of shuttle valves that are in fluid communication with the multiple pressure relief valve and the plurality of actuators such that said multiple pressure relief valve may be switched between the plurality of pressure settings in response to the load conditions existing at more than two actuators.

6. The hydraulic system of claim 1 which includes a plurality of actuators that are in fluid communication with the pump and the control valve, said system being adapted to receive a pilot signal from more than one of the plurality of actuators.

7. The hydraulic system of claim 1 wherein the means for automatically varying the maximum pressure level in the system comprises a pressure switch that is adapted to automatically determine the load conditions existing at the actuator and automatically vary the pressure setting of the multiple pressure relief valve.

8. The hydraulic system of claim 1 which includes a means for manually varying the maximum pressure level in the system between the plurality of maximum pressure levels of the multiple pressure relief valve.

9. The hydraulic system of claim 8 wherein the means for manually varying the maximum pressure level in the system comprises an electrical switch adapted to electrically communicate with the switching device.

10. The hydraulic system of claim 8 wherein the means for manually varying the maximum pressure level in the system comprises a pneumatic switch adapted to pneumatically communicate with the switching device.

11. The hydraulic system of claim 1 wherein the multiple pressure relief valve comprises a plurality of independent pressure relief valves having different pressure settings.

12. The hydraulic system of claim 11 wherein a plurality of switching devices are in fluid communication with said plurality of pressure relief valves having different pressure settings.

13. A hydraulic system having two pressure relief limits, said system comprising:
(a) a hydraulic actuator having a cap end and a rod end;
(b) a hydraulic pump that is in fluid communication with the hydraulic actuator, said pump being adapted to provide hydraulic fluid under pressure to said actuator;
(c) a control valve that is in fluid communication with the hydraulic actuator and the hydraulic pump, said control valve being adapted to control the flow of fluid to the cap end and the rod end of the hydraulic actuator;
(d) a dual pressure relief valve that is in fluid communication with the hydraulic pump, the actuator, and the control valve, said dual pressure relief valve having a lower pressure setting adapted to provide a lower maximum pressure level in the system and a higher pressure setting adapted to provide a higher maximum pressure level in the system;
(e) means for automatically varying the maximum pressure level in the system between the two maximum pressure levels of the dual pressure relief valve;
(f) means for manually varying the maximum pressure level in the system between the two maximum pressure levels of the dual pressure relief valve;
(g) a switching device that is in fluid communication with the dual pressure relief valve and the means for automatically varying the maximum pressure level in the system, said switching device being adapted to switch between an open position and a closed position and vary the pressure setting of the dual pressure relief valve;
wherein the pressure level in the system is maintained at or below about the lower maximum pressure level of the lower pressure setting of the dual pressure relief valve until either the means for automatically varying the maximum pressure level in the system or the means for manually varying the maximum pressure level in the system is actuated so as to switch the dual pressure relief valve to the higher pressure setting, thereby increasing the pressure level in the system to a level higher than the lower maximum pressure level but no higher than the higher maximum pressure level of the higher pressure setting of the dual pressure relief valve until the means for automatically varying the maximum pressure level in the system or the means for manually varying the maximum pressure level in the system returns the dual pressure relief valve to the lower pressure setting.

14. The hydraulic system of claim 13 which includes a plurality of actuators that are in fluid communication with the pump and the control valve, said system further comprising a shuttle valve that is in fluid communication with the dual pressure relief valve and the plurality of actuators such that said dual pressure relief valve may be switched between the plurality of pressure settings in response to the load conditions existing at more than one actuator.

15. The hydraulic system of claim 13 which includes a plurality of actuators that are in fluid communication with the pump and the control valve, said system further comprising a plurality of shuttle valves that are in fluid communication with the dual pressure relief valve and the plurality of actuators such that said dual pressure relief valve may be switched between the plurality of pressure settings in response to the load conditions existing at more than two actuators.

16. The hydraulic system of claim 13 which includes a plurality of actuators that are in fluid communication with the pump and the control valve, said system being adapted to receive a pilot signal from more than one of the plurality of actuators.

17. The hydraulic system of claim 13 wherein the means for manually varying the maximum pressure level in the system comprises an electrical switch adapted to electrically communicate with the switching device.

18. The hydraulic system of claim 13 wherein the means for manually varying the maximum pressure level in the system comprises a pneumatic switch adapted to pneumatically communicate with the switching device.

19. The hydraulic system of claim 13 wherein the lower pressure setting of the dual pressure relief is about 2500 p.s.i. and the higher pressure setting of the dual pressure relief valve is about 3500 p.s.i.

20. The hydraulic system of claim 13 wherein the means for automatically varying the maximum pressure level in the system is adapted to switch the dual pressure relief valve from the lower pressure setting to the higher pressure setting when the operating pressure in the system is at or above about a predetermined pressure level.
